(19) United States
(12) Patent Application Publication
(10) Pub. No.: US 2016/0237257 A1
(43) Pub. Date: Aug. 18, 2016

(54) ELASTOMERIC COMPOSITIONS COMPRISING IONOMERS

(71) Applicant: Eastman Chemical Company, Kingsport, TN (US)

(72) Inventors: Pruthesh Hariharrao Vargantwar, Kingsport, TN (US); Frederick Ignatz Hoover, Elyria, OH (US); Soumendra Kumar Basu, Copley, OH (US); Bradley James Helmer, Kingsport, TN (US); Christopher George Robertson, Parma, OH (US); Michael Eugene Donelson, Kingsport, TN (US); Marcus David Shelby, Fall Branch, TN (US)

(73) Assignee: Eastman Chemical Company, Kingsport, TN (US)

(21) Appl. No.: 15/040,006

(22) Filed: Feb. 10, 2016

Related U.S. Application Data
(60) Provisional application No. 62/115,389, filed on Feb. 12, 2015.

(51) Int. Cl. C08L 9/06

(52) U.S. Cl. CPC C08L 9/06

(57) ABSTRACT

An elastomeric composition is provided comprising at least one elastomer, at least one ionomer, at least one filler, and optionally at least one coupling agent. A process of making the elastomeric composition is also provided as well as articles comprising the elastomeric composition. In particular, tires comprising the elastomeric composition are provided wherein the handling and processing characteristics are improved while other performance characteristics are retained.

### CROSS REFERENCE TO RELATED APPLICATIONS

This application claims priority to U.S. Provisional Application Ser. No. 62/115,389 filed Feb. 12, 2015, the disclosure of which is herein incorporated by reference in its entirety.

### FIELD OF THE INVENTION

The invention belongs to the field of elastomeric compositions comprising at least one elastomer, at least one ionomer, at least one filler, and optionally at least one coupling agent. Processes for producing the elastomeric compositions are also provided as well as articles produced utilizing the elastomeric compositions, in particular, tires.

### BACKGROUND OF THE INVENTION

Tire formulations containing filler can be difficult to process due to their high viscosities at processing conditions. Silica and/or carbon black are often used as fillers in these formulations. For example, the surfaces of the precipitated silica nanoparticles are very polar leading to strong filler-filler interactions and agglomeration, and this behavior is a major contributor to the difficult processing of silica-filled rubber. Long mixing times and or repeated mixing cycles are mostly required to make these formulations usable in elastomeric and tire applications.

To overcome this shortcoming, processing aids, such as oil, are often included in these formulations that help mixing by diluting the elastomeric composition. Alternatively, reduced filler loadings can be used. Although these approaches improve processing, significant negative impacts on the performance properties of the final vulcanized tire compound are seen, which depending on end-use application conditions include reduced tire wear resistance, grip/traction and cornering coefficient (CC) or handling.

By incorporating processing aids such as oils, for example, treated distillate aromatic extract (TDAE), and soaps in tire compounds their processing can be improved. However, addition of soaps and oils often degrade performance of the final vulcanized tire compound by negatively affecting its dynamic mechanical properties. Alternatively, silica coupling agents can be included in the tire compound. However, the problem of long processing times still exists.

Handling has been improved by addition of crosslinking resins, for example, resins crosslinked typically by methylene donors. While in processing the resin can act as a processing aid, but later in presence of a crosslinking agent can crosslink with itself during the rubber vulcanization step to form high T_{g} domains, thereby stiffening (increasing low strain modulus: G′ if measured in shear or E′ if measured in tensile modes of testing) of the compound. Increased G′ indicates better handling and cornering characteristics in tread compounds.

Although processing aids, such as oil used in silica formulations, help in compound mixing primarily through compound dilution, they reduce the E′ of the compound and increase its hysteretic behavior consequently deteriorating its rolling resistance. In general, coupling agents can maintain good rolling resistance characteristics, but also negatively affect E′ of the final compound thus worsening the tire handling characteristics.

While the crosslinking resins improve handling characteristics of the final vulcanized compound, the performance can gradually drop due to slow degradation of the resin network under cyclic strains encountered during the lifetime of the tire. This also can result in increased hysteretic behavior and poor rolling resistance. Besides these drawbacks, the use of crosslinking resins can come with environmental concerns of formaldehyde release over a period of time.

There is a need in the industry for an additive for elastomeric compositions, particularly those used in tires, that can improve processing without affecting performance properties.

### BRIEF SUMMARY OF THE INVENTION

In one embodiment of the invention, an elastomeric composition is provided comprising at least one elastomer, at least one ionomer, at least one filler and at least one coupling agent.

In another embodiment of the invention, a process to produce an elastomeric composition is provided. The process comprises mixing at least one elastomer, at least one ionomer, at least one filler, and at least one coupling agent to produce an elastomeric composition.

In yet another embodiment of the invention, an article is provided comprising an elastomeric composition; wherein the elastomeric composition comprises at least one elastomer, at least one ionomer, at least one filler, and at least one coupling agent. Specifically, a tire is provided comprising the elastomeric composition.

### BRIEF DESCRIPTION OF THE FIGURES

FIG. 1 shows performance of tire tread compounds containing ionomers compared to comparative examples.

### DETAILED DESCRIPTION

An elastomeric composition is provided comprising at least one elastomer, at least one ionomer, at least one filler and optionally at least one coupling agent.

The term “elastomer,” as used herein, can be used interchangeably with the term “rubber.” Due to the wide applicability of the process described herein, the ionomers can be employed with virtually any type of elastomer. For instance, the elastomers utilized in this invention can comprise a natural rubber, a modified natural rubber, a synthetic rubber, and mixtures thereof.

In some embodiments of this invention, the elastomer can be a polar rubber compound. The polar elastomer can be at least one selected from the group consisting of chlorinated rubbers, nitrile rubbers, polyacrylate rubbers, ethylene acrylic rubbers, and polyurethanes.

In certain embodiments of the present invention, at least one of the elastomers is a non-polar elastomer. For example, a non-polar elastomer can comprise at least about 90, 95, 98, 99, or 99.9 weight percent of non-polar monomers. In one embodiment, the non-polar elastomer is primarily based on a hydrocarbon. Examples of non-polar elastomers include, but are not limited to, natural rubber, polybutadiene rubber, polyisoprene rubber, butyl rubber, styrene-butadiene rubber, polyolefins, ethylene propylene monomer rubber (EPM), ethylene propylene diene monomer (EPDM) rubber, and polynorbornene rubber. Examples of polyolefins include, but are not limited to, polybutylene, polyisobutylene, and ethylene propylene rubber. In another embodiment, the elastomer comprises a natural rubber, a styrene-butadiene rubber, and/or a polybutadiene rubber. Non-polar elastomers are often used in tire components.

In certain embodiments, the elastomer contains little or no nitrile groups. As used herein, the elastomer is considered a “non-nitrile” elastomer when nitrile monomers make up less than 10 weight percent of the elastomer. In one embodiment, the elastomer contains no nitrile groups.

In an embodiment of the invention, diene rubbers are utilized having an iodine number of between about 20 to about 400. Illustrative of the diene rubbers that can be utilized are polymers based on conjugated dienes, such as, for example, 1,3-butadiene; 2-methyl-1,3-butadiene; 1,3-pentadiene; 2,3-dimethyl-1,3-butadiene; and the like, as well as copolymers of such conjugated dienes with monomers, such as, for example, styrene, alpha-methylstyrene, acetylene (e.g., vinyl acetylene), acrylonitrile, methacrylonitrile, methyl acrylate, ethyl acrylate, methyl methacrylate, ethyl methacrylate, vinyl acetate, and the like. In one embodiment, highly unsaturated rubbers include natural rubber, cis-polyisoprene, polybutadiene, poly(styrene-butadiene), styrene-isoprene copolymers, isoprene-butadiene copolymers, styrene-isoprene-butadiene tripolymers and like. Moreover, mixtures of two or more highly unsaturated rubbers with elastomers having lesser unsaturation such as EPDM, EPR, and butyl or halogenated butyl rubbers are also within the contemplation of the invention. These later elastomers may also make a major component of the elastomer mix. At least one of the elastomers (or the elastomer if not a mixture) is a non-polar elastomer. For example, a non-polar primary elastomer can comprise at least about 90, 95, 98, 99, or 99.9 weight percent of non-polar monomers.

The elastomeric diene polymers usable as the elastomer in the present invention may be selected from those commonly used in sulfur, peroxide or metal peroxide vulcanizable elastomeric compositions, particularly suitable for tire manufacture. In one embodiment, unsaturated chain elastomeric polymers or copolymers having a glass transition temperature generally lower than 20° C. can be utilized. In other embodiments, the glass transition temperature is between about 0° and about −90° C. Such polymers or copolymers may be of natural origin or may be obtained synthetically by solution or emulsion polymerization of one or more conjugated diolefins, possibly mixed with one or more monovinylarenes in an amount generally not higher than 50% by weight. The elastomer can contain little or no nitrile/halogenated groups.

The ionomers utilized in the elastomeric composition can be any that is known in the art. An ionomer is a macromolecule containing at least one ionizable or ionic group. In an embodiment of the invention, the ionomer is a macromolecule in which a small but significant proportion of the units have ionizable or ionic groups, or both. Ionomers can differ in macromolecular backbone structure, ionic or ionizable group type and the neutralizing counterion if present. In another embodiment of the invention, the ionomer comprises between about 1 and about 40 mole % ionizable or ionic groups. In other embodiments, there are about 3 to about 25 mole % or about 8 to about 20 ionizable or ionic groups.

Ionizable groups include, but are not limited to, carboxylic, sulfuric, sulfonic, phosphonic, phosphoric, amines. These groups can be present in the ionizable or partially/completely neutralized forms.

The neutralizing cations include, but are not limited to, alkali metals, such as sodium, potassium, and lithium; alkaline earth metals, such as calcium, magnesium, beryllium, strontium, or barium; and transition metals. The transition metals contemplated for use herein include Group VIII metals, such as nickel; Group IIB metals, such as zinc; Group VIIB metals, such as manganese; and others. Exemplary non-metallic cations contemplated for use herein include ammonium.

The ionomer backbone can be any that is known in the art. In one embodiment, the ionomer is an all-carbon backbone polymer that is either linear or branched. All-carbon backbone polymers (linear or branched) are defined as polymers having a main hydrocarbon chain to which groups are attached. These include the families of addition polymers such as polyolefins, styrenics, acrylics, methacrylics, and vinyls.

Commercially available ionomers can be used to carry out the present invention. Cation-neutralized copolymers of ethylene and acrylic acid are commercially available under the trademark Escor® and/or Lotek® from Exxon Chemical Co., Houston, Tex. The lithium and potassium neutralized copolymers of ethylene and acrylic acid are commercially available under the trademark Lotek® from Exxon Chemical Co., Houston, Tex. The Escor® and/or Lotek® copolymers vary from one another as to neutralizing ion (such as sodium, potassium, lithium, calcium, magnesium or zinc), the ratio of the ethylene and acrylic acid components, and the percentage of neutralization. Ionic copolymers of ethylene and methacrylic acid are commercially available under the trademark Surlyn® by E. I. DuPont de Nemours & Co., Wilmington, Del. Like the Escor® copolymers, the Surlyn® copolymers also differ from one another as to neutralizing ion (such as sodium or zinc), the ratio of components, and the percentage of neutralization. Specific examples of suitable commercially available ionic polymers contemplated in this invention include, but not limited to, Escor® 4000 and Escor® 900 (Escor® 4000 and 900 have since been re-named as Lotek® 7030 and Iotek® 8000); Lotek® EX-989, -990, -991, -992, -993, or -994; the DuPont copolymers Surlyn® PC-2000, 1559, 7930, or 8528; Escor® 4200, 906, 562, 8020, 8030, 7010, or 7020; Hi-Milan® 7311 sold by Mitsui-Dupont Polychemicals Co. LTD., Tokyo 100, Japan, which is neutralized with magnesium cations; and others. Perfluorinated ionomers such as Nafion® and Flemion® made by DuPont and Asahi Glass respectively can also potentially be used in this invention. More than one ionomer can be used in the tire formulations of this invention.

Ionizable ionomer forms can also find use in this invention. The examples include, but are not limited to, copolymers of ethylene and acrylic acid; copolymers of ethylene and methacrylic acid; copolymers of propylene and acrylic acid; and terpolymers of ethylene, acrylic or methacrylic acid.

Specific examples of ionizable ionomers include, but are not limited to, ethylene-methacrylic acid copolymers, ethylene-acrylic acid copolymers and polystyrene sulfonate polymers. An ethylene-acrylic acid copolymer is commercially available under the trademark Primacor® (Dow Chemical Co., Midland, Mich.), while an ethylene-methacrylic acid copolymer is commercially available under the trademark Nucrel® (E. I. DuPont de Nemours & Co., Wilmington, Del.). Other non-ionic copolymers which are useful here, such as polypropylene-acrylic acid copolymers, are commercially available under the trademark Polybond® (BP Performance Polymers Inc., Hackettstown, N.J.). Nonionic terpolymers that are suitable for use in the present invention include the ethylene-acrylic acid based terpolymers which are commercially available under the ESCOR® trademark, such as ATX 310, ATX 320, ATX 325, and ATX 350, from Exxon.

Additional examples of ionomers that can be used for this invention are styrenic ionomers, partially crystalline ionomers, zwiterionic ionomers, polystyrene sulfonates, and copolymers of acrylic acid and sulfonated monomers. Commercial polystyrene sulfonates suitable for the invention include grades such as Flexan II® and Versa® polystyrene sulfonates produced by Akzo Nobel. Commercial copolymers of acrylic acid and sulfonated monomers include Aquatreat® grades produced by Akzo Nobel.

Other examples of ionomers include, but are not limited to, butadiene-acrylic acid, perfluorosulfonate, perfluorocarboxylate, telechelic polybutadiene, sulfonated ethylene-propylene terpolymer, styrene-acrylic acid copolymer, sulfonated polystyrene, sulfonated butyl elastomer, and sulfonated polypentenamer.

The ionomer can also have a hetero-atom (non-carbon) backbone polymer that is either linear or branched. A hetero-atom (non-carbon) backbone is defined as polymers having the main hetero (non-carbon) atoms in the main chain to which groups are attached. These include the families of condensation polymers, such as, polyesters, polyamides, polyurethanes, polycarbonates, and polyethers.

In one embodiment of the invention, the ionomer is a water-dissipatable polyester or polyesteramide. The water-dissipatable polyester or polyesteramide can be prepared by reacting a glycol component, a dicarboxylic acid component, and at least one difunctional comonomer wherein a portion of the comonomer contains a sulfonate group in the form of a metallic salt, the sulfonate group being attached to an aromatic nucleus. The linear, water-dissipatable polyester or polyesteramide can have an inherent viscosity of at least 0.1 or at least 0.3.

The glycol component of the invention advantageously comprise at least about 15 mole percent of at least one poly(ethylene glycol) have the formula:

HOCH₃—CH₂ₙOH

Wherein n is 2 to about 20.

More especially, this invention provides a linear, water-dissipatable polymer having carbonyloxy interconnecting groups in the linear molecular structure wherein up to 80% thereof may be carbonylamido linking groups, the polymer having an inherent viscosity of at least about 0.1 measured in a 60/40 parts by weight solution of phenol/tetrachloroethane at 25° C. and at a concentration of about 0.25 gram of polymer in 100 ml of the solvent, the polymer consisting essentially of at least (a), (b) and (c) from the following components:
(a) At least one difunctional dicarboxylic acid;
(b) At least one difunctional glycol containing two —CR₂—OH groups of which at least 15 mole percent is a poly(ethylene glycol) having the structural formula

HOCH₃—CH₂ₙOH

n being an integer in the range between about 2 and about 20;
(c) An amount sufficient to provide said water-dissipatable characteristic of the polymer of at least one difunctional sulfo-monomer containing at least one metal sulfonate group attached to an aromatic nucleus wherein the functional groups are hydroxyl, carboxyl or amino; and
(d) From none to an amount of a difunctional hydroxycarboxylic acid having one —CR₂—OH group, an aminocarboxylic acid having one —NRH group, an amino-alcohol having one —CR₂—OH group and one —NRH group, a diamine having two —NRH groups, or a mixture thereof, wherein each R is an H atom or a 1-4 carbon alkyl group, the components (a), (b), (c) and (d) being organic compounds each of which contains a hydrocarbon moiety which has from none up to six non-functional groups, and where (A) represents all of the carboxy functional groups in the polymer from all of the components and (B) represents all of the functional hydroxy and functional amino groups in the polymer from all of said components, the ratio of the (A) to (B) in the polymer is substantially unity, whereby the polymer is essentially linear. According to one aspect of this invention, there is provided a polymer which is a polyester wherein said difunctional sulfo-monomer is a dicarboxylic acid and constitutes about 8 mole percent to about 50 mole percent based on the sum of (1) the moles of the total dicarboxylic acid content of components (a) and (b), and (2) one half of the moles of any hydroxycarboxylic acid content from said component (d).

According to more specific embodiments, such polyesters are provided wherein said difunctional sulfomonomer (c) is a glycol and constitutes about 8 mole percent to about 50 mole percent based on the sum of (1) the total glycol content measured in moles of (b) and (c), and (2) one half of the moles of any hydroxycarboxylic acid from said component (d).

The aforesaid range is most preferably from about 10 up to about 50 mole percent.

Examples of suitable poly(ethylene glycols) include diethylene glycol, triethylene glycol, tetraethylene glycol and pentaethylene, hexaethylene, heptaethylene, octaehtylene, nonaethylene, and decaethylene glycols and mixtures thereof. Preferably the poly(ethylene glycol) employed in the polyesters or polyesteram ides of the present invention is diethylene glycol or triethylene glycol or mixtures thereof. The remaining portion of the glycol component may consist of aliphatic, alicyclic, and aralkyl glycols. Examples of these glycols include ethylene glycol; propylene glycol; 1,3-propanediol; 2,4-dimethyl-2-ethylhexane-1,3-diol; 2,2-dimethyl-1,3-propanediol; 2-ethyl-2-butyl-1,3-propanediol; 2-ethyl-2-isobutyl-1,3-propanediol; 1,3-butanediol; 1,4-butanediol; 1,5-pentanediol; 1,6-hexanediol; 2,2,4-trimethyl-1,6-hexanediol; thiodiethanol; 1,2-cyclohexanedimethanol; 1,3-cyclohexanedimethanol; 1,4-cyclohexanedimethanol; 2,2,4,4-tetramethyl-1,3-cyclobutanediol; p-xylylenediol. Copolymers may be prepared from two or more of the above glycols.

The dicarboxylic acid component of the polyester or polyesteramide comprises aliphatic dicarboxylic acids, alicyclic dicarboxylic acids, aromatic dicarboxylic acids, or mixtures of two or more of these acids. Examples of such dicarboxylic acids include oxalic; malonic; dimethylmalonic; succinic; glutaric; adipic; trimethyladipic; pimelic; 2,2-dimethylglutaric; azelaic; sebacic; fumaric; maleic; itaconic; 1,3-cyclopentanedicarboxylic; 1,2-cyclohexanedicarboxylic; 1,3-cyclohexanedicarboxylic; 1,4-cyclohexanedicarboxylic; phthalic; terephthalic; isophthalic; 2,5-norbornanedicarboxylic; 1,4-naphthalic; diphenic; 4,4′-oxydibenzoic; diglycolic; thiodipropionic; 4,4′-sulfonyldibenzoic; and 2,5-naphthalenedicarboxylic acids. If terephthalic acid is used as the dicarboxylic acid component of the polyester, superior results are achieved when at least 5 mole percent of one of the other acids listed above is also used.

It should be understood that use of the corresponding acid anhydrides, esters, and acid chlorides of these acids is included in the term “dicarboxylic acid”. Examples of these esters include dimethyl 1,4-cyclohexandicarboxylate; dimethyl 2,6-naphthalenedicarboxylate; dibutyl4,4′-sulfonyldibenzoate; dimethyl isophthalate; dimethyl terephthalate; and diphenyl terephthalate. Copolyesters may be prepared from two or more of the above dicarboxylic acids or derivatives thereof.

The difunctional sulfo-monomer component of the polyester or polyesteramide may advantageously be a dicarboxylic acid or an ester thereof containing a metal sulfonate group or a glycol containing a metal sulfonate group or a hydroxy acid containing metal sulfonate group. The metal ion of the sulfonate salt may be Na+, Li+, K+, Mg++, Ca++, Cu++, Ni++, Fe++, Fe+++ and the like. It is possible to prepare the polyester or polyesteramide using, for example, a sodium sulfonate salt and later by ion-exchange replace this ion with a different ion, for example, calcium, and thus alter the characteristics of the polymer. In general, this procedure is superior to preparing the polymer with divalent metal salt inasmuch as the sodium salts are usually more soluble in the polymer manufacturing components than are the divalent metal salts. Polymers containing divalent or trivalent metal ions are less elastic and rubber-like than polymers containing monovalent ions. The difunctional monomer component may also be referred to as a difunctional sulfo-monomer.

Advantageous difunctional components which are aminoalcohols include aromatic, aliphatic, heterocyclic and other types as in regard to component (d). Specific examples include 5-aminopentanol-1, 4-aminomethylcyclohexanemethanol, 5-amino-2-ethyl-pentanol-1, 2-(4-β-hydroxyethoxyphenyl)-1-aminoethane, 3-amino-2,2-dimethylpropanol, hydroxyethylamine, etc. Generally these aminoalcohols contain from 2 to 20 carbon atoms, one —NRH group and one —CR₂—OH group.

Advantageous difunctional monomer components which are aminocarboxylic acids include aromatic aliphatic, heterocyclic, and other types as in regard to component (d) and include lactams. Specific examples include 6-aminocaproic acid, its lactam known as caprolactam, omega-aminoundecanoic acid, 3-amino-2-dimethylpropionic acid, 4-(β-aminoethyl) benzoic acid, 2-(,β-aminopropoxy) benzoic acid, 4-aminomethylcyclohexanecarboxylic acid, 2-(β-aminopropoxy) cyclohexanecarboxylic acid, etc. Generally these compounds contain from 2 to 20 carbon atoms.

Advantageous examples of difunctional monomer component (d) which are diamines include ethylenediamine; hexamethylenediamine; 2,2,4-trimethylhexamethylenediamine; 4-oxaheptane-1,7-diamine; 4,7-dioxadecane-1,10-diamine; 1,4-cyclohexanebismethylamine; 1,3-cyclo-heptamethylenediamine; dodecamethylenediamine, etc.

Some specific example grades of polyesters include Eastman AQ® polymers. The chemistry of these ionomer(s) is described in the U.S. Pat. No. 3,734,874 and U.S. Pat. No. 3,779,993, herein incorporated by reference. Some examples of commercially made AQ polymers are AQ™ 1359, 1950, 2350, 38 S, 48 ultra, 55S and 65S.

Examples of polyurethane ionomers can be found in U.S. Pat. No. 5,504,145, herein incorporated by reference.

Examples of carboxylated polyesters can be found in U.S. Pat. No. 5,552,475, herein incorporated by reference.

In one embodiment of the invention, the carboxylated polyester ionomer can be prepared by the reaction of a polyol with a polycarboxylic acid, a polycarboxylic anhydride, or a lower alkyl ester. Both cyclic or acyclic polyols or mixtures thereof may be used. Examples of suitable polyols include 1,4-cyclohexanediol, 1,4-cyclohexanedimethanol, propylene glycol, diethylene glycol, 1,4-butanediol, neopentyl glycol, 1,6-hexanediol, trimethylpentanediol and dipropylene glycol. In addition, one or more polycarboxylic acids (or the corresponding anhydrides, if available) can be used in the preparation of the polyester. These polycarboxylic acids can be cyclic, acyclic or a mixture thereof. Esters, particularly methyl esters of these acids may also be used as reactants from which the polyesters may be formed by transesterification. Suitable cyclic polycarboxylic acids include orthophthalic acid, isophthalic acid, terephthalic acid, hexahydrophthalic acid, methylhexahydrophthalic acid and cyclohexyldicarboxylic acid (or dimethylcyclohexyldicarboxylate). The acyclic polycarboxylic acids with a carbon number range between 2 and 36 may also be exployed, for example, oxalic acid, malonic acid, succinic acid, glutaric acid, adipic acid, suberic acid, azelaic acid, sebacic acid, undecanedioic acid, dodecanedioic acid, furmaric acid, and maleic acid.

The ionomers suitable for this invention may further contain additives such as plasticizers, stabilizers (antioxidants, IR or UV absorbers etc.) anti-blocking agents, compatibilizers, crosslinkers as well as many other additives known to one skilled in the art. For example, the ionomer can include one or more plasticizers in the amount of 0 to 50 wt % of the ionomer. Any plasticizer or mixture of plasticizers known to those skilled in the art for use with ionomers can be used.

The amount of ionomer added to the elastomeric composition can range from about 1 to about 30 phr. Other ranges are from about 2 to about 25 phr and about 2 to about 15 phr.

The filler in the elastomeric composition of this invention can be any that is known in the art. The amount of filler in the elastomeric composition can range from about 1 to about 400 phr. In other embodiments, the amount of filler can range from about 5 to about 200 phr, from about 20 to about 150 phr, and from about 50 to about 120 (phr=parts by weight per 100 parts of rubber). The filler may be selected from those commonly employed for crosslinked products, and in particular for tires, such as, silica, carbon black, clay, alumina, talc, mica, discontinuous fibers including cellulose fibers and glass fibers, aluminum silicate, aluminum trihydrate, barites, feldspar, nepheline, antimony oxide, calcium carbonate, kaolin, and combinations thereof. In some embodiments, the filler is carbon black, silica, inorganic and nonpolymeric material or mixtures thereof.

Examples of suitable silica fillers include, but are not limited to, pre-treated silicas, precipitated silicas, amorphous silicas, vitreous silicas, fumed silicas, fused silicas, synthetic silicates, such as, aluminum silicates, alkaline earth metal silicates, such as, magnesium silicates and calcium silicates, natural silicates, such as, kaolins and other naturally occurring silicas and the like. Also useful are highly dispersed silicas having surface areas of from about 5 to about 1000 m²/g or from about 20 to about 400 m²/g as measured by BET analysis. Highly dispersed silicas having primary particle diameters of from about 5 to about 500 nm or from about 10 to about 400 nm can be utilized. These highly dispersed silicas can be prepared by, for example, precipitation of solutions of silicates or by flame hydrolysis of silicon halides. The silicas can also be present in the form of mixed oxides with other metal oxides, such as, for example, Al, Mg, Ca, Ba, Zn, Zr, Ti oxides and the like. Commercially available silica fillers known to one skilled in the art include, but are not limited to, Cab-O-Sil® silica from Cabot Corporation, Hi-Sil®, Ceptane® and Agilon™ silica from PPG Industries; Zeosil® silica from Rhodia, and Ultrasil® and Coupsil® silica from Degussa AG. Mixtures of two or more silica fillers can be used in preparing the elastomeric composition of this invention.

When silica is utilized as the filler, the amounts can vary widely. Generally, the amount of silica filler can range from about 5 and 200 phr, about 20 and about 150 phr, and about 50 to about 120 phr.

If desired, carbon black fillers can be employed with the silica or other filler(s) in forming the elastomeric compositions of this invention. Suitable carbon black fillers include any of the commonly available, commercially-produced carbon black fillers known to one skilled in the art. The carbon black fillers, if any, are ordinarily incorporated into the elastomeric composition in amounts ranging from about 1 to about 100 phr or from about 5 to about 65 phr.

In one embodiment of the invention, carbon black having a surface area (EMSA) of at least 20 m²/g is utilized. In other embodiments, the surface area of the carbon black is at least 35 m²/g. In yet other embodiments, the surface area is 200 m²/g or higher. Surface area values used in this application are those determined by ASTM Test D-3765 using the cetyltrimethyl-ammonium bromide (CTAB) technique. Among the useful carbon black fillers are furnace blacks, channel blacks and lamp blacks. More specifically, examples of the carbon black fillers include super abrasion furnace (SAF) blacks, high abrasion furnace (HAF) blacks, fast extrusion furnace (FEF) blacks, fine furnace (FF) blacks, intermediate super abrasion furnace (ISAF) blacks, semi-reinforcing furnace (SRF) blacks, medium processing channel blacks, hard processing channel blacks and conducting channel blacks. Other carbon black fillers, which may be utilized, include acetylene blacks. Mixtures of two or more of the above carbon black fillers can be used in preparing the elastomeric compositions of the invention. The carbon black fillers utilized in the invention may be in pelletized form or an unpelletized flocculant mass.

The elastomeric composition also contains at least one coupling agent. The coupling agent can be any that is known in the art for use in elastomeric compositions. Such coupling agents, for example, may be premixed, or pre-reacted, with the filler or added during the elastomer/filler processing, or mixing stage. If the coupling agent and filler are added separately to the elastomer during the elastomer/filler mixing, or processing stage, the coupling agent can combine in situ with the filler. In particular, such coupling agents are generally composed of a silane which has a constituent component, or moiety, (the silane portion) capable of reacting with the silica surface and, also, a constituent component, or moiety, capable of reacting with the rubber, e.g., a sulfur vulcanizable rubber which contains carbon-to-carbon double bonds, or unsaturation. In this manner, then, the coupling agent acts as a connecting bridge between the silica and the rubber thereby enhancing the rubber reinforcement aspect of the silica.

The silane component of the coupling agent may form a bond to the filler surface, possibly through hydrolysis, and the rubber reactive component of the coupling agent combines with the rubber itself. Generally, the rubber reactive component of the coupling agent is temperature sensitive and tends to combine with the rubber during the final and higher temperature sulfur vulcanization stage, i.e., subsequent to the rubber/filler/coupling agent mixing stage and after the silane group of the coupling agent has combined with the filler. However, partly because of typical temperature sensitivity of the coupling agent, some degree of combination, or bonding, may occur between the rubber-reactive component of the coupling agent and the rubber during an initial rubber/filler/coupling agent mixing stage and prior to a subsequent vulcanization stage.

Suitable rubber-reactive group components of the coupling agent include, but are not limited to, one or more of groups such as mercapto, amino, vinyl, epoxy, and sulfur groups. In other embodiments, the rubber-reactive group components of the coupling agent is a sulfur or mercapto moiety with a sulfur group being most preferable.

Examples of a coupling agent for use herein are vinyltrichlorosilane, vinyltrimethoxysilane, vinyltriethoxysilane, vinyltris(β-methoxyethoxy)silane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, -β(aminoethyl)-γ-aminopropylmethyldimethoxysilane, N-β-(aminoethyl)γ-aminopropyltrimethoxysilane, N-β(aminoethyl)γ-aminopropyltriethoxysilane, γ-aminopropyltrimethoxysilane, γ-aminopropyltriethoxysilane, -phenyl-γ-aminopropyltrimethoxysilane, γ-chloropropyltrimethoxysilane, γ-mercaptopropyltrimethoxysilane and combinations thereof.

Representative examples of the sulfur-containing coupling agents are sulfur-containing organosilicon compounds. Specific examples of suitable sulfur-containing organosilicon compounds are of the following general formula:

Z—R¹—Sₙ—R²—Z

in which Z is selected from the group consisting of

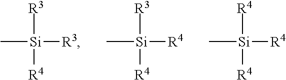

wherein R³ is an alkyl group of from 1 to 4 carbon atoms, cyclohexyl or phenyl; and R⁴ is an alkoxy of from 1 to 8 carbon atoms, or cycloalkoxy of 5 to 8 carbon atoms; and R¹ and R² are independently a divalent hydrocarbon of from 1 to 18 carbon atoms and n is an integer of from about 2 to about 8.

Specific examples of sulfur-containing organosilicon compounds which may be used herein include, but are not limited to, 3,3′-bis(trimethoxysilylpropyl)disulfide, 3,3′-bis(triethoxysilylpropyl)disulfide, 3,3-bis(triethoxysilylpropyl)tetrasulfide, 3,3′-bis(triethoxysilylpropyl)octasulfide, 3,3′-bis(trimethoxysilylpropyl)tetrasulfide, 2,2′-bis(triethoxysilylethyl)tetrasulfide, 3,3′-bis(trimethoxysilylpropyl)triasulfide, 3,3′-bis(triethoxysilylpropyl)triasulfide, 3,3′-bis(tributoxysilylpropyl)disulfide, 3,3′-bis(trimethoxysilylpropyl)hexasufide, 3,3′-bis(trimethoxysilylpropyl)octasulfide, 3,3′-bis(trioctoxysilylpropyl)tetrasulfide, 3,3′-bis(trihexoxysilylpropyl)disulfide, 3,3′-bis(tri-2″-ethylhexoxysilylpropyl)trisulfide, 3,3′-bis(triisooctoxysilylpropyl)tetrasulfide, 3,3′-bis(tri-t-butoxysilyl-propyl)disulfide, 2,2′-bis(methoxydiethoxysilylethyl)tetrasulfide, 2,2′-bis(tripropoxysilylethyl)pentasulfide, 3,3′-bis(tricyclohexoxysilylpropyl)tetrasulfide, 3,3′-bis(tricyclopentoxysilylpropyl)trisulfide, 2,2′-bis(tri-2″-methyl-cyclohexoxysilylethyl)tetrasulfide, bis(trimethoxysilylmethyl)tetrasulfide, 3-methoxy ethoxy propoxysilyl 3′-diethoxybutoxy-silylpropyltetrasulfide, 2,2′-bis(dimethyl methoxysilylethyl)disulfide, 2,2′-bis(dimethyl sec.butoxysilylethyl)trisulfide, 3,3′-bis(methyl butylethoxysilylpropyl)tetrasulfide, 3,3′-bis(di t-butylmethoxysilylpropyl)tetrasulfide, 2,2′-bis(phenylmethylmethoxysilylethyl)trisulfide, 3,3′-bis(diphenyl isopropoxysilylpropyl)tetrasulfide, 3,3′-bis(diphenyl cyclohexoxysilylpropyl)disulfide, 3,3′-bis(dimethylethylmercaptosilylpropyl)tetrasulfide, 2,2′-bis(methyldimethoxysilylethyl)trisulfide, 2,2′-bis(methyl ethoxypropoxysilylethyl)tetrasulfide, 3,3′-bis(diethyl methoxysilylpropyl)tetrasulfide, 3,3′-bis(ethyl di-sec. butoxysilylpropyl)disulfide, 3,3′-bis(propyl diethoxysilylpropyl)disulfide, 3,3′-bis(butyl dimethoxysilylpropyl)trisulfide, 3,3′-bis(phenyl dimethoxysilylpropyl)tetrasulfide, 3-phenyl ethoxybutoxysilyl 3′-trimethoxysilyipropyl tetrasulfide, 4,4′-bis(trimethoxysilylbutyl)tetrasulfide, 6,6′-bis(triethoxysilylhexyl)tetrasulfide, 12,12′-bis(triisopropoxysilyl dodecyl)disulfide, 18,18′-bis(trimethoxysilyloctadecyl)tetrasulfide, 18,18′-bis(tripropoxysilyl-octadecenyl)tetrasulfide, 4,4′-bis(trimethoxysilylbutene-2-yl)tetrasulfide, 4,4′-bis(trimethoxysilylcyclohexylene)tetrasulfide, 5,5′-bis(dimethoxymethyl-silylpentyl)trisulfide, 3,3′-bis(trimethoxysilyl-2-methylpropyl)tetrasulfide, 3,3′-bis(dimethoxyphenylsilyl-2-methylpropyl)disulfide and the like. The preferred coupling agents are 3,3′-bis(triethoxysilylpropyl)disulfide and 3,3′-bis(triethoxysilylpropyl)tetrasulfide.

When the coupling agent is present, the amount of coupling agent can range from about 0.1 to about 15 wt % and from about 1 to about 8 wt %, based on the amount of filler.

Additionally, at least one other common additive can be added to the rubber compositions of this invention, if desired or necessary, in a suitable amount. Suitable common additives for use herein include vulcanizing agents, activators, retarders, antioxidants, compatibilizers, anti-blocking agents, plasticizing oils and softeners, fillers other than silica and carbon black, reinforcing pigments, antiozonants, waxes, tackifier resins, crosslinking resins, processing aids, carrier elastomers, tackifiers, lubricants, waxes, surfactants, stabilizers, UV absorbers/inhibitors, pigments, extenders, reactive coupling agents, and/or branchers and combinations thereof. In one embodiment, the additives comprise a non-ionomer processing aid. This processing aid can comprise, for example, a processing oil, and/or water. This processing aid can comprise, for example, a processing oil, and/or water. In such an embodiment, the elastomeric composition can comprise a processing aid in an amount less than 50 phr, based on the total weight of the elastomers. In other embodiments, the amount of processing aid ranges from less than 40 phr, less than 30 phr, less than 20 phr, and less than 10 phr, based on the total weight of the elastomers. Additionally or alternatively, the elastomeric composition can exhibit a weight ratio of ionomer to processing aid of at least about 0.5:1, 1:1, 2:1, 3:1, 4:1, 5:1, 8:1, or 10:1.

The compositions according to the present invention may be vulcanized according to known techniques, and in particular with sulfur-based vulcanizing systems commonly employed for diene elastomers. To this end, after the first few thermal-mechanical working (mixing) steps, a sulfur-based vulcanizing agent is incorporated in the composition together with vulcanization activators and accelerators. In this working step, the temperature is generally kept below 120° C., preferably below 100° C., to prevent undesired pre-cross-linking phenomena.

A process is also provided to produce the elastomeric composition. The process comprises mixing at least one elastomer, at least one ionomer, at least one filler, and optionally at least one coupling agent. The mixing can be accomplished by any method that is known in the art that is adequate to disperse the ionomer. Mixing may be carried out for instance by means of an open-mill type mixer, or by means of an internal mixer of the type with tangential (Banbury) or interpenetrating (Intermix) rotors, or in continuous mixers of the Ko-Kneader (Buss) type, or of twin-screw co-rotating or counter-rotating type. Also, any of the fillers and ionomers may be pre-mixed into a carrier elastomer base to make a concentrated batch and then mixed with the final formulation. The elastomer of the concentrated batch can be the same or different than the elastomer or elastomers used in the elastomeric compositions. The mixing and addition sequences for the components can vary.

The elastomeric compositions of the present invention can be incorporated into various types of end products.

In certain embodiments, the elastomeric composition is formed into a tire and/or a tire component. The tire component can comprise, for example, tire tread, subtread, undertread, body plies, belts, overlay cap plies, belt wedges, shoulder inserts, tire apex, tire sidewalls, bead fillers, and any other tire component that contains an elastomer. In one embodiment, the elastomeric composition is formed into tire tread, tire sidewalls, and/or bead fillers. These include the tread, sidewall, and carcass portions intended for, but not exclusive to, a truck tire, passenger tire, off-road vehicle tire, vehicle tire, high speed tire, and motorcycle tire that also contain many different reinforcing layers therein. Such rubber or tire tread compositions in accordance with the invention may be used for the manufacture of tires or for the re-capping of worn tires.

In certain embodiments, the elastomeric composition is incorporated into non-tire applications. Non-tire applications include, for example, a blowout preventer, fire hoses, weather stripping, belts, injection molded parts, footwear, pharmaceutical closures, plant lining, flooring, power cables, gaskets, seals, and architectural trims. In particular, the cellulose ester/elastomer compositions can be utilized in various oil field applications such as, for example, blowout preventers, pump pistons, well head seals, valve seals, drilling hoses, pump stators, drill pipe protectors, down-hole packers, inflatable packers, drill motors, O-Rings, cable jackets, pressure accumulators, swab cups, and bonded seals.

Unlike the other solutions described in the previous section, adding ionomers to filler tire formulations simultaneously improves its processing and subsequently μ (ratio of G′ from RPA @ 5% strain to M300 modulus) of the final vulcanized compound. Additionally, unlike the crosslinking resins listed above, the μ enhancements achieved may not deteriorate significantly during the life of the tire.

This invention achieves simultaneous improvements in processing of tire compounds and subsequent μ characteristics in tires made using these compounds without significantly deteriorating other tire physical and performance characteristics. Most mechanical properties improve when ionomer is used in the formulation. In addition, manufacturing is improved as mixing time and or energy utilization may as well be reduced.

### EXAMPLES

The following test methods were utilized in these examples to determine properties of elastomeric compositions.

Cure Rheometer: Oscillating Disk Rheometer (ODR) was performed according to ASTM D 2084. Tₛ2 is the time it takes for the torque of the rheometer to increase 2 units above the minimum value. T_{c}90 is the time to reach 90% of the difference between minimum to maximum torque.

The Mooney Viscosities were measured according to ASTM D 1646.

Hot Molded Groove Trouser Tear (at 100° C.): Molded groove trouser tear (Type CP modified trouser tear test piece with a constrained path for tear) was performed according to ASTM test method D624.

Break stress and break strain were measured as per ASTM D412 using Die C for specimen preparation. The speed of testing was 20 inches/min, and the gauge length was 63.5 mm (2.5 inch). The samples were conditioned in the lab for 40 hours at 50%+/−5% humidity and 72° F. The width of the specimen was 1 inch, and length was 4.5 inch.

Dynamic Mechanical Analysis (Temperature Sweeps): 1) Instrument DMA Q800 V20.26 Build 45 was used in tensile mode to perform the temperature sweep experiment. The experimental conditions were 1 Hz with 5% dynamic strain. The heating rate of 3° C./minute was used for a temperature range of −30° C. to 60° C. after a 10 minute hold at −30° C.

### Examples 1-5

Tire Performance Parameters were Determined for the Tire compositions containing ionomers having formulations as shown in Table 1. Processing steps for producing the elastomeric compositions are shown in Table 2. Examples C1-C4 were comparative examples where no ionomer was utilized. I4 was the inventive example. Examples C3 and C4 utilized cellulose ester additives (CEA) rather than ionomers.

TABLE 1
Formulations of tire tread compounds containing
select polymers as additives

| | | Examples | | | | |
|---|---|---|---|---|---|---|
| Ingredients | Description | C1 | C2 | C3 | C4 | I5 |

Stage 1 mix conditions

| | | | | | | |
|---|---|---|---|---|---|---|
| Buna ® VSL | S-SBR, | 89.4 | 89.4 | 89.4 | 89.4 | 89.4 |
| 5025-2¹ | 37.5 phr | | | | | |
| | TDAE, high | | | | | |
| | vinyl (67% | | | | | |
| | of buta- | | | | | |
| | diene, | | | | | |
| | 25% Sulfur | | | | | |
| Buna ® CB24² | PBD rubber | 35.0 | 35.0 | 35.0 | 35.0 | 35.0 |
| Ultrasil ® 7000 | Silica | 65.0 | 80.0 | 65.0 | 65.0 | 65.0 |
| GR³ | | | | | | |
| Continex ® N234⁴ | Carbon Black | 15.0 | 15.0 | 15.0 | 15.0 | 15.0 |
| ~Si 266⁵ | Struktol ® | 5.1 | 6.2 | 5.1 | 5.1 | 5.1 |
| | SCA 985 | | | | | |
| Stearic acid | Cure | 1.5 | 1.5 | 1.5 | 1.5 | 1.5 |
| | Activator | | | | | |
| Products of | MB1 | 211.0 | 227.1 | 211.0 | 211.0 | 211.0 |
| Stage 1 | | | | | | |

Stage 2 mix conditions

| | | | | | | |
|---|---|---|---|---|---|---|
| masterbatch | MB1 | 211.0 | 227.1 | 211.0 | 211.0 | 211.0 |
| CEA-1⁶ | Polymer | 0.0 | 0.0 | 17.3 | 0.0 | 0.0 |
| CEA-2⁷ | Polymer | 0.0 | 0.0 | 0.0 | 18.8 | 0.0 |
| Ethylene | Polymer | 0.0 | 0.0 | 0.0 | 0.0 | 15.0 |
| copolymers/ | | | | | | |
| ionomers, | | | | | | |
| partially | | | | | | |
| neutralized | | | | | | |
| (Surlyn ® PC-2000) | | | | | | |
| ~Si 266 | Struktol ® | 0.0 | 0.0 | 1.2 | 1.2 | 0.0 |
| | SCA 985 | | | | | |
| Zinc oxide | Cure | 1.9 | 1.9 | 1.9 | 1.9 | 1.9 |
| | activator | | | | | |
| Okerin ® wax | micro- | 1.5 | 1.5 | 1.5 | 1.5 | 1.5 |
| 7240⁸ | crystalline | | | | | |
| | wax | | | | | |
| Santoflex ® 6PPD⁹ | 6PPD | 2.0 | 2.0 | 2.0 | 2.0 | 2.0 |
| Product of Stage 2 | MB2 | 216.4 | 232.5 | 234.8 | 236.3 | 231.4 |

Stage 3(productive) mix conditions

| | | | | | | |
|---|---|---|---|---|---|---|
| Masterbatch | MB2 | 216.4 | 232.5 | 234.8 | 236.3 | 231.4 |
| Sulfur | Cross-linker | 1.3 | 1.3 | 1.3 | 1.3 | 1.3 |
| CBS¹⁰ | Accelerator | 1.1 | 1.1 | 1.1 | 1.1 | 1.1 |
| DPG¹¹ | Accelerator | 1.3 | 1.3 | 1.3 | 1.3 | 1.3 |
| Total | | 220.0 | 236.2 | 238.4 | 239.9 | 235.0 |

¹Solution Styrene Butadiene Rubber obtained from Lanxess containing treated distillate aromatic extract.
²Polybutadiene Rubber obtained from Lanxess.
³Silica obtained from Evonik Industries.
⁴Carbon black obtained from Continental Carbon.
⁵Silane coupling agent obtained from Struktor Company.
⁶Cellulose Acetate Butyrate additive obtained from Eastman Chemical Company.
⁷Cellulose Acetate Propionate additive obtained from Eastman Chemical Company.
⁸Microcrystalline wax obtained from Sovereign Chemical.
⁹Anti-oxidant obtained from Flexsys.
¹⁰n-cyclohexyl-2-benzothiazole
¹¹diphenyl guanidine

A Farrel BR Banbury mixer was utilized with steam heating and water cooling which was instrumented with computer monitors for temperature, rpm, and power. Table 2 shows the processing steps.

TABLE 2
Processing of tire tread compounds containing select polymers as additives
Stage 1 mix conditions

| | |
|---|---|
| start temperature | 65° C. |
| starting rotor speed, rpm | 65 |
| fill factor | 70% |
| ram pressure | 50 psi |
| mix sequence | at 0 min add elastomers |
| | at 1 min add 2/3 silica + Si266 |
| | at 2 min add 1/3 silica + others |
| | at 3 min sweep |
| | at 3.5 min adjust (increase) rotor speed, ramp |
| | temperature to 160° C. at 4.5 min |
| dump conditions | hold 2 min at 160° C. (total mix time = 6.5 min) |
| Mill Conditions | RT mill with knife flips for 2 min |

Stage 2 mix conditions

| | |
|---|---|
| start temperature | 65° C. |
| starting rotor speed, rpm | 65 |
| fill factor | 67% |
| ram pressure | 50 psi |
| mix sequence | at 0 min add 1/2 of first pass batch |
| | at 0.25 min add other ingredients in a low-melt |
| | bag and 1/2 of first pass batch. |
| | at 1 min sweep. |
| | at 1.5 min adjust (increase) rotor speed, ramp |
| | temperature to 150° C. at 3.5 min |
| dump conditions | Hold 4 min at 155° C. (total mix time = 7.5 min) |
| Mill Conditions | RT mill with knife flips for 2 min |

Stage 3 (productive) mix conditions

| | |
|---|---|
| start temperature | 50° C. |
| starting rotor speed, rpm | 60 |
| fill factor | 64% |
| ram pressure | 50 psi |
| addition order | at 0 min 1/2 2nd pass batch, at 0.25 min add |
| | sulfur, accelerator pocket, & 1/2 2nd pass |
| | batch, sweep at 1 min. |
| dump conditions | 110° C. or 2.5 min |
| Mill Conditions | RT mill with knife flips for 2 min |

Tests were conducted on each of the formulations to determine performance properties.

TABLE 3
Performance of tire tread compounds containing select polymers as additives

| | | | | DIN | | | | | G′ at | | | | | | | |
|---|---|---|---|---|---|---|---|---|---|---|---|---|---|---|---|---|
| | Initial | Mooney | Shore | abrasion | | | | | 30° C., | | G′ | | tanδ | | | |
| | Mooney | ML(1 + 4) | A | (volume | | Break | Mod | Mod | 5% | μ^{b} | at −20 | | 30° C., | | | |
| | Day 2 | Day 2 | hard- | loss in | TS^{a} | strain | 100% | 300% | strain | (kPa/ | C. | tanδ | 5% | tanδ | Ts2 | T90 |
| Ex. | (MU) | (MU) | ness | cu mm) | (MPa) | (%) | (MPa) | (MPa) | in shear | Mpa) | (kPa) | 0° C. | strain | 60° C. | (min) | (min) |
| 1 | 125.0 | 84.0 | 61 | 66 | 19.66 | 460.5 | 2.54 | 10.65 | 1490 | 139.89 | 9298 | 0.427 | 0.224 | 0.201 | 2.17 | 10.5 |
| 2 | 156.0 | 98.3 | 65 | 91 | 18.13 | 398.2 | 2.99 | 12.25 | 1590 | 129.81 | 10710 | 0.476 | 0.235 | 0.224 | 2.02 | 11.8 |
| 3 | 105.0 | 76.0 | 64 | 101 | 17.52 | 476.2 | 2.60 | 9.42 | 1840 | 195.43 | 10440 | 0.449 | 0.252 | 0.191 | 2.24 | 6.5 |
| 4 | 113.0 | 76.3 | 64 | 112 | 19.15 | 532.2 | 2.94 | 9.43 | 1930 | 204.76 | 10070 | 0.434 | 0.253 | 0.193 | 2.24 | 7.1 |
| 5 | 87.2 | 50.5 | 67 | 71 | 17.67 | 417.9 | 3.13 | 11.58 | 2120 | 183.15 | 10120 | 0.383 | 0.236 | 0.195 | 2.72 | 16.0 |

^{a}TS = tensile strength
^{b}μ (kPa/MPa) = ratio of G′ in shear @ 30° C., 5% strain to M300 modulus

Example 1 was a comparative example. Thermoplastic polymers (cellulose ester additives and ionomers) as listed in Table 1 were added to the formulation of Example 1 to demonstrate performance enhancements. Example 2 is another comparative example which contains 15 phr of silica additionally added to the Example 1 formulation.

The initial Mooney viscosity values (peak values in Mooney tests) for the comparative formulations in Examples 1 & 2 were significantly higher than in Example 5 containing Surlyn® PC-2000 ionomer resin. The ML(1+4) values (plateau values after 4 min of Mooney testing) were significantly lower than the Comparative Examples 1&2 indicating possible reduction in number of mixing stages and mixing time of the compounds. Handling properties showed substantial increase through increase in G′ values when ionomers were present. Scorch time in presence of Surlyn® PC-2000 ionomer resin improved compared to the Comparative Examples. The change (increase in viscosity) in initial Mooney viscosities (that correlated with the extent of filler agglomeration) during storage, may not be as much (increase in viscosity) in example having Surlyn® PC-2000 compared to comparatives. Increase in initial viscosity limits the storage life span of mixed compounds. Thus, incorporation of ionomers in formulations may facilitate longer storage time for the mixed formulations.

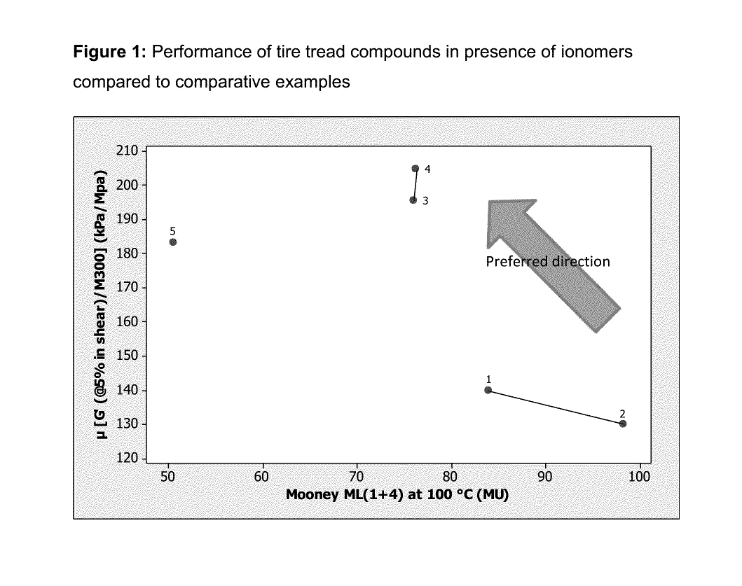

Compared to Examples 1 and 2, CEA containing formulations (Examples 3 and 4) showed improved Mooney viscosity and enhanced μ simultaneously. See FIG. 1 below. However, Surlyn® PC-2000 containing Example 5 demonstrated much higher increase in μ than the comparatives (1 and 2) and is similar to CEA containing examples 3 and 4. Parameter ‘μ’ can be related to the handling performance of the tires fabricated from these formulations, where higher values are considered better. Example 5 containing Surlyn® PC-2000 demonstrated the maximum benefit in terms of Mooney viscosity which directly relates to the ease of processability of elastomeric formulations such as in the case of tires. The desired Mooney viscosity for a given application can be achieved by tuning the formulation and processing protocol. The change (increase in viscosity) in initial Mooney viscosities (that correlate with the extent of filler agglomeration) during storage, was not as much in example having Surlyn® PC-2000 compared to comparatives and CEA containing examples. Increase in initial viscosity limits the storage life span of mixed compounds. Thus, incorporation of ionomers in formulations may facilitate longer storage time for the mixed formulations. Abrasion resistance as given by DIN abrasion numbers was unaffected compared to Comparative Example 1 and was better than CEA containing samples when Surlyn® PC-2000 is present in the formulation.

That which is claimed:

1. An elastomeric composition comprising at least one elastomer, at least one ionomer, at least one filler, and optionally at least one coupling agent; wherein said ionomer comprises a backbone structure and at least one ionic or ionizable group.

2. The elastomeric composition according to claim 1 wherein said elastomer is selected from the group consisting of natural rubber, a modified natural rubber, a synthetic rubber, and mixtures thereof.

3. The elastomeric composition according to claim 1 wherein at least one of the elastomers is a non-polar elastomer.

4. The elastomeric composition according to claim 3 wherein said non-polar elastomers are selected from the group consisting of natural rubber, polybutadiene rubber, polyisoprene rubber, butyl rubber, styrene-butadiene rubber, polyolefins, ethylene propylene monomer rubber (EPM), ethylene propylene diene monomer (EPDM) rubber, and polynorbornene rubber.

5. The elastomeric composition according to claim 1 wherein said ionomer further comprises a neutralizing counterion.

6. The elastomeric composition according to claim 1 wherein said ionic or ionizable group is at least one selected from the group consisting of carboxylates, sulfates, sulfonates, phosphates, phosphonates, and quaternary amines.

7. The elastomeric composition according to claim 5 wherein neutralizing cation is at least one selected from the group consisting of alkali metals, alkaline earth metals, and transition metals.

8. The elastomeric composition according to claim 5 wherein said neutralizing counterion is ammonium.

9. The elastomeric composition according to claim 1 wherein said ionomer backbone structure is a linear or branched all-carbon backbone polymer.

10. The elastomeric composition of claim 9 wherein said all-carbon backbone polymer is selected from the group consisting of polyolefins, styrenics, acrylics, methacrylics, and vinyls.

11. The elastomeric composition according to claim 1 wherein said ionomer is a ionizable ionomer selected from the group consisting of copolymers of ethylene and acrylic acid; copolymers of ethylene and methacrylic acid; copolymers of propylene and acrylic acid; ethylene-acrylic acid based terpolymers, and polystyrene sulfonate polymers.

12. The elastomeric composition according to claim 1 wherein said ionomer is at least one selected from the group consisting of styrenic ionomers, partially crystalline ionomers, zwiterionic ionomers, polystyrene sulfonates, copolymers of acrylic acid and sulfonated monomers, butadiene-acrylic acids, perfluorosulfonates, perfluorocarboxylates, telechelic polybutadienes, sulfonated ethylene-propylene terpolymers, styrene-acrylic acid copolymers, sulfonated polystyrenes, sulfonated butyl elastomers, and sulfonated polypentenamers.

13. The elastomeric composition according to claim 1 wherein said backbone structure is a linear or branched hetero-atom (non-carbon) polymer.

14. The elastomeric composition according to claim 13 wherein said linear or branched hetero-atom polymer is selected from the group consisting of polyesters, polyamides, polyurethanes, polycarbonates, and polyethers.

15. The elastomeric composition according to claim 1 wherein the amount of said ionomer ranges from about 1 to about 30 phr.

16. The elastomeric composition of claim 1 wherein said ionomer comprises from about 1 to about 40 mole % ionizable or ionic groups.

17. The elastomeric composition of claim 1 wherein said ionomer comprises from about 3 to about 25 mole % ionizable groups.

18. The elastomeric composition according to claim 1 wherein said ionomer is an AQ® polymer.

19. An article comprising the elastomeric composition of claim 1.

20. A tire comprising the elastomeric composition of claim 1.
